(19) United States
(12) Patent Application Publication
(10) Pub. No.: US 2014/0104041 A1
(43) Pub. Date: Apr. 17, 2014

(54) ENCODED ANTENNA ARRAY AND METHOD

(71) Applicant: Michael L. Potter, Huntsville, AL (US)

(72) Inventor: Michael L. Potter, Huntsville, AL (US)

(73) Assignee: AVOCENT HUNTSVILLE CORP., Huntsville, AL (US)

(21) Appl. No.: 14/122,297

(22) PCT Filed: May 25, 2012
(86) PCT No.: PCT/US2012/039566

§ 371 Date: Nov. 26, 2013

Related U.S. Application Data
(60) Provisional application No. 61/491,573, filed on May 31, 2011.

(51) Int. Cl. G06K 7/10

(52) U.S. Cl. CPC G06K 7/10356
USPC 340/10.1

(57) ABSTRACT

A system for identifying which equipment slots of an equipment enclosure have equipment components located in them when specific equipment components containing radio frequency identification (RFID) tags thereon are inserted into specific ones of the equipment slots. The system may use a plurality of antenna elements that wirelessly sense the presence of an RFID tag at any of the equipment slots, and which generate outputs that may be interpreted as forming a plurality of codes. Each code is uniquely associated with a specific one of the equipment slots. A decoder system may read the output signals from the antenna elements to thus obtain the code and determine which specific ones of the equipment slots that an RFID tag was sensed at.

### CROSS REFERENCE TO RELATED APPLICATIONS

This application claims the benefit of U.S. Provisional Application No. 61/491,573, filed on May 31, 2011. The entire disclosure of the above application is incorporated herein by reference.

### FIELD

The present disclosure relates to equipment identification systems for identifying equipment, and more particularly to an identification system and method for identifying the locations of specific equipment components in a data center environment using an antenna system that makes use of an encoded array of antennas.

### BACKGROUND

The statements in this section merely provide background information related to the present disclosure and may not constitute prior art.

In a data center it is often required, or desirable, to be able to identify where each equipment component is located. Often a data center may have dozens or even hundreds or thousands of independent equipment components, many or most of which may be housed in a plurality of equipment racks. Various systems and methods have been attempted to provide different ways of tracking the locations of specific equipment components within a data center. Such systems and methods have occasionally involved the use of antenna systems to sense radio frequency identification (“RFID”) tags that are placed on the individual pieces of equipment. When a specific piece of equipment is placed in a shelf of an equipment rack and its respective RFID tag comes into proximity with an antenna mounted adjacent to the shelf, the antenna is able to wirelessly read the information encoded in the RFID tag via an RF signal emitted from the RFID tag. The antenna then provides an output to a different subsystem wherein a data center worker is apprised, often on a display terminal, where the specific piece of equipment is located within the data center environment.

One such prior art antenna system is shown in FIG. 1. The system in FIG. 1 can sense the presence of any one of 15 different RFID tags associated with 15 different pieces of equipment at 15 different locations, but is not able to discern any one piece of equipment from any other piece of equipment. Thus, for example, if seven of the 15 sites had equipment each with its own ID tag, the system of FIG. 1 would only be able to indicate that at least one RFID tag was being sensed, and in this specific example would indicate that all seven pieces of equipment would be present. However, the system of FIG. 1 would not be able to identify exactly which specific site any of the seven pieces of equipment is located at.

FIG. 2 illustrates another prior art implementation that makes use of a dedicated antenna for each possible equipment location. Each one of the 15 independent antennas is able to receive the RF signal from a single RFID tag uniquely associated with a single piece of equipment. Each antenna transmits a signal over a dedicated transmission channel to the subsystem where the location of the specific piece of equipment can be identified. Thus, while the antenna system of FIG. 2 is able to uniquely identify the location of each piece of equipment, as one can immediately appreciate this type of system becomes more and more expensive as a greater number of individual pieces of equipment, each having their own respective RFID tag, are used in the data center. Fifty different pieces of equipment needing to be identified would require fifty different antennas and 50 different transmission channels, 500 different pieces of equipment would require 500 different antennas and 500 different transmission channels, and so on. Thus, it will be apparent that the cost of implementing such a system quickly can become prohibitively expensive when dozens, hundreds or even thousands of independent pieces of equipment need to be tracked within a data center environment. And this doesn't even take into account the complexity and volume of cabling that would need to be routed within the data center environment so that an independent antenna could be located at each and every location where separate pieces of equipment are installed.

### SUMMARY

In one aspect the present disclosure relates to a system for identifying which equipment slots of an equipment enclosure have equipment components located in them when specific equipment components containing radio frequency identification (RFID) tags thereon are inserted into specific ones of the equipment slots. The system may comprise an antenna system adapted to be secured to the equipment enclosure to span the equipment slots. The antenna system may include a plurality of elongated antenna elements arranged adjacent to one another and in relation to the equipment slots of the equipment enclosure. The antenna elements may be configured to wirelessly sense the presence of an RFID tag at any one of the equipment slots and to generate a plurality of different codes. Each code may be uniquely associated with at least a given one of the equipment slots, and thus will be indicative of the sensed presence of an RFID tag at its associated equipment slot. A decoder system may be included which is in communication with the antenna system. The decoder system may be used for decoding the unique codes generated by the antenna system and determining which specific ones of the equipment slots that an RFID tag was sensed at.

In another aspect the present disclosure relates to a system for identifying which equipment slots of an equipment enclosure have equipment components located in them when specific equipment components containing radio frequency identification (RFID) tags thereon are inserted into specific ones of the equipment slots. The system may comprise an antenna system adapted to be secured to said equipment enclosure to span the equipment slots. The antenna system may include a plurality of elongated antenna elements arranged adjacent to one another and in relation to the equipment slots of the equipment enclosure. Each of the elongated antenna elements may have at least one first portion along a length thereof which is able to receive signals generated by a wireless RFID tag, and at least one second portion along a length thereon which is not able to receive signals from a wireless RFID tag. The antenna elements may be configured to wirelessly sense the presence of an RFID tag at any one of the equipment slots and, using the first and second portions of the antenna elements, to generate a plurality of different binary codes. Each binary code may represent a unique binary code that is uniquely associated with at least a given one of the equipment slots, and is indicative of the sensed presence of an RFID tag at its associated equipment slot. A decoder system may be included which is in communication with the antenna system. The decoder system may be used for reading the binary codes generated by the antenna system and determining which specific ones of the equipment slots that an RFID tag was sensed at.

In still another aspect the present disclosure relates to a method for identifying which equipment slots of an equipment enclosure have equipment components located in them when specific equipment components containing radio frequency identification (RFID) tags thereon are inserted into specific ones of the equipment slots. The method may comprise securing a multi element antenna system to the equipment enclosure in a manner such that the antenna system spans all the equipment slots. The method may further involve selectively insulating one or more portions of the multi element antenna system along a length of each element of the multi element antenna system such that a wirelessly sensed RFID tag at any one of the equipment slots causes a unique output to be generated by the elements of the multi element antenna system. This may cause a plurality of codes to be generated by the elements of the multi element antenna system, with each code being uniquely associated with a different one of the equipment slots. The method may further involve reading output signals from each of the antenna elements to construct the codes. The method may further involve using a decoder system to interpret the codes to thus determine which one or more of the equipment slots has an equipment component installed therein.

### BRIEF DESCRIPTION OF THE DRAWINGS

The drawings described herein are for illustration purposes only and are not intended to limit the scope of the present disclosure in any way.

FIG. 1 is an illustration of a prior art system involving one antenna being used to sense the signals from RFID tags at any one of a plurality of 15 different equipment site locations;

FIG. 2 is an illustration of a prior art system in which a plurality of 15 independent antennas are used to sense the signals from RFID tags at 15 different equipment sites;

FIG. 3 is a high level diagram of an encoded antenna system in accordance with one embodiment of the present disclosure being used to sense the presence of an RFID tag at a plurality of 15 different equipment locations within an equipment rack;

FIG. 4 is another embodiment of the antenna system of FIG. 3 illustrating a plurality of antennas formed in a multilayer Mylar assembly;

FIG. 5 is a table illustrating the outputs from the antenna systems of FIG. 3, and the deduced equipment locations, when various codes are received by various antenna elements of the antenna system; and

FIG. 6 is a graph illustrating how the reduction in the total number of antennas required for use with the present system and method decreases exponentially as the number of different sites needing to be sensed increases.

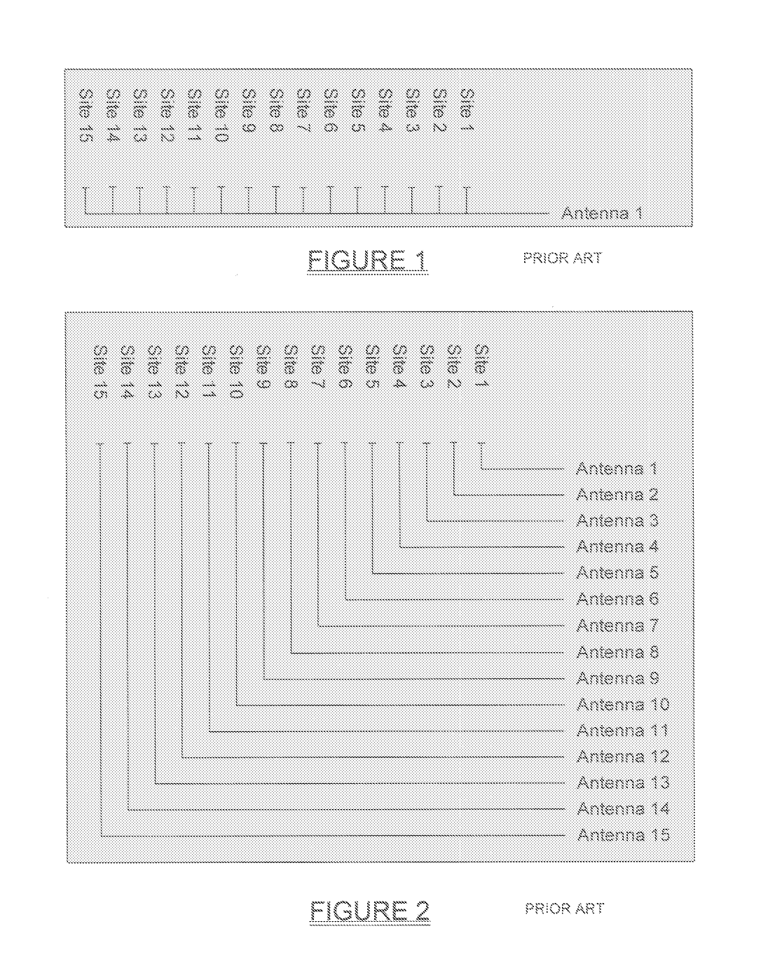

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring to FIG. 3 there is shown an encoded antenna system 10 in accordance with one embodiment of the present disclosure. The antenna system 10 is unique in that it makes use of an encoding scheme to dramatically reduce the number of independent antennas that are required to sense the presence and absence of a plurality of independent pieces of equipment within a data center environment. Also, while it will be appreciated that the present disclosure is especially well suited to tracking the locations of pieces of equipment within a large modern day data center, the teachings presented herein could be used in tracking/sensing the location of a wide variety of other items in a wide variety of settings or environments. The only requirement is that one location's RF generating identification component needs to be readable by a portion of the antenna system 10. Thus, it will be appreciated that the present disclosure may find utility in warehouses, factories or any other environments where a plurality of assets needs to be tracked.

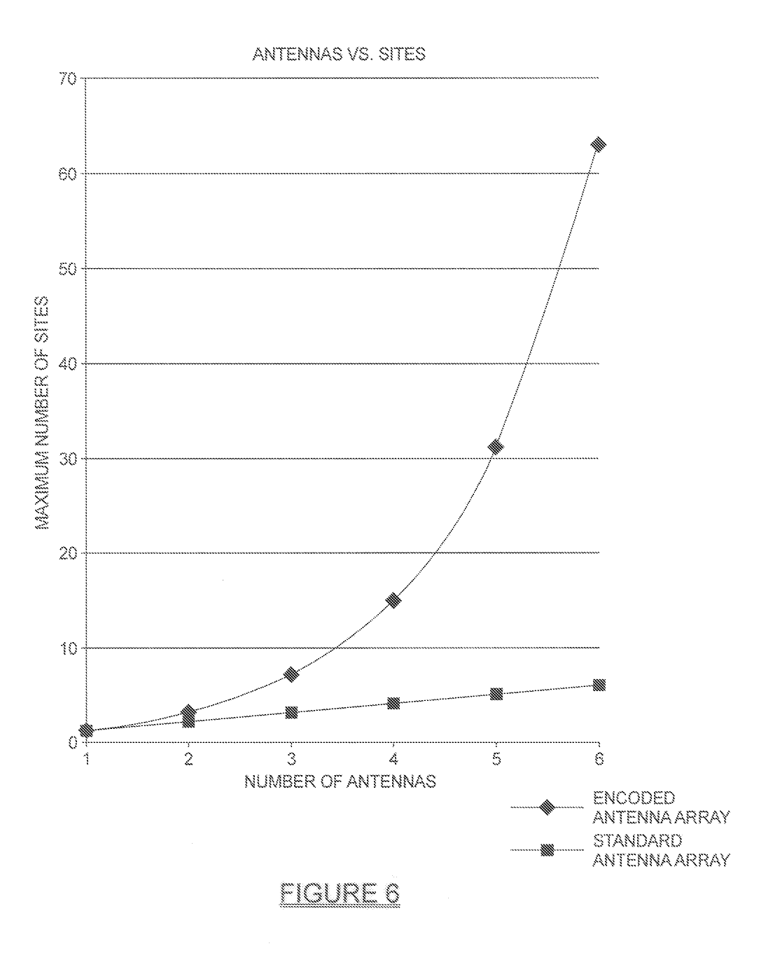

In FIG. 3 the system 10 is shown positioned closely adjacent an equipment rack 12 that has 15 shelves, denoted by numbers “1” through “15”, for holding up to 15 different pieces of data center equipment. Each equipment shelf is further identified with a code, in this example a binary number, and has an RFID tag associated with it. The RFID tags are denoted in FIG. 3 simply by “RFID 1”, “RFID 2”, and so forth. Each RFID tag is thus uniquely associated with one specific piece of equipment, and with at least one shelf. However, a given RFID tag may be encoded to indicate that its associated piece of equipment will be using more than one shelf spot, depending on its physical size, but such information would also be provided in its RFID tag. Thus, when a piece of data center equipment is first obtained an RFID tag may be encoded for it that includes various information about the component (e.g., type of component; manufacturer, serial number, shelf requirements, power requirements, etc.). For discussion purposes it will be assumed that RFID tags 1-15 are encoded with codes “A” through “O”, which are each unique. In the Table of FIG. 5, to be discussed shortly, it can be seen that the RFID tag associated with shelf 1 is encoded with code “B”, the RFID tag associated with shelf 2 is encoded with code “F”, and so forth. In other words the codes do not necessarily need to be sequentially assigned to the RFID tags or to the shelves.

Each RFID tag may be secured to each piece of equipment in any suitable manner, but typically will be secured with an adhesive backed sticker assembly so that the RFID tag can simply be adhered to a portion of the housing of its associated piece of equipment. The RFID tag is further typically located on an area of the housing that is adjacent to a rear or side area of the equipment rack 12. The RFID tags are preferably further placed generally at a common location on each piece of equipment such that when all the pieces of equipment are installed in the equipment rack 12, the RFID tags will be presented along a generally straight, vertical line. This allows the antenna 14 to be secured in a vertical orientation closely adjacent (e.g., typically within about 1.0 inch; 2-3 cm) to all of the RFID tags. However, while a vertical, linear orientation of the antenna 14 may be especially effective, it will be appreciated that the antenna 14 could be implemented in horizontal or other orientations to meet the needs of a specific equipment setup. It will also be appreciated that the antenna system 10 may be used with equipment racks that hold a greater or lesser number of individual pieces of equipment. The system 10 may even be used with individual pieces of equipment that are not necessarily supported in equipment racks but otherwise located in a manner that makes it possible to arrange a multi-element antenna assembly along a plurality of the pieces of equipment.

The RFID tags in this example may be “passive” RF tags. By “passive” it is meant that each RFID tag is able to receive an RF signal from an external signal source and to generate a response thereto by which it transmits a reply RF signal with its stored identifying information. One example of suitable identifying information could be a serial number of the equipment to which it is affixed.

Referring further to FIG. 3, the system 10 makes use of an antenna 14 which in this example has four independent antenna elements 14a-14d. Dipole antenna elements are especially well suited for this application, although other forms of antennas, such as highly directional antennas, could potentially be used as well. The antenna 14 may be interfaced to a RFID Reader/Decoder subsystem 16 having its own central processing unit (CPU) 16a. The RFID Reader/Decoder subsystem 16 (hereinafter simply the “decoder subsystem 16”) may be interfaced to a computer system 18 having a display terminal or any other suitable component for displaying information decoded by the information relating to the signals obtained by the antenna elements 14a-14d. Alternatively, the decoder subsystem 16 may be integrated into the computer system 18. Either the decoder subsystem 16 or the computer system 18 may contain a table or chart that correlates the shelf location that is associated with each possible binary output code generated by the antenna 14. Thus, for example, the system 10 will know that the binary output code “0011” generated by the antenna system 14 corresponds to shelf location 3 in the equipment rack 12, that the binary output “1111” corresponds to shelf location 15, and so forth.

In FIG. 3 the antenna 14 forms a “binary” encoded antenna. So antenna element 14a is associated with a first bit (i.e., 2⁰ bit) of a binary number, the second antenna element 14b is associated with the second (2¹ bit), the third antenna element 14c is associated with the third bit (2² bit) and the fourth antenna element 14d is associated with the fourth bit (2³ bit). Each of the antenna elements 14a-14d effectively forms a distinct transmission “channel”. Moreover, each antenna element 14a-14d may include a plurality of distinct, “reception” sections, one for each of the 15 shelves in the equipment rack 12. The reception sections are spaced such that when the antenna 14 is secured adjacent to the equipment rack 12, the reception sections reside adjacent to one or more of the shelves 1-15 of the equipment rack 12.

In this example each of the RFID tags 1-15 is treated as being located at a distinct location that is associated with the binary number of one specific shelf of the equipment rack 12. Therefore, antenna 14 will be formed such that for shelf location 1 (0001), the reception section of the antenna 14 will have only a single reception area, represented schematically by dipole element 20 of antenna element 14a (i.e., no dipole elements will be present on antenna elements 14b-14d at this reception location). For shelf location 2 (0010), the reception section of the antenna 14 will only have one dipole element 20, and that dipole element will be associated with antenna element 14b (i.e., no dipole elements will be present on antenna elements 14a, 14c or 14d at this reception location). At shelf location 10 (1010), the reception section of antenna 14 will have dipole elements 20 from only antenna elements 14b and 14d (i.e., no dipole elements will be present from antenna elements 14a and 14c). For the last shelf location 15 (1111), the reception section will be provided by a dipole element 20 from each one of the four antenna elements 14a-14d.

Each antenna element 14a-14d may be formed in any suitable manner, but in one implementation each antenna element 14a-14d may be formed by a separate length of coaxial cable. A suitable shielding may be placed over the outer surface of the outermost insulating layer of material on the cable. The shield may be placed at appropriate locations along the length of each antenna element 14a such that only small, designated lengths of each antenna element 14a-14d are able to receive RF signals from the RFID tags. These designated lengths form the sections of each antenna element 14a-14d that collectively make up the reception sections described above. As an example, antenna element 14a will have sections masked off with shielding material to prevent reception of RF signals at those areas that correspond to binary locations where the “1” bit is not needed to form the binary output (i.e., at any odd numbered shelf location). Antenna element 14b will be masked off such that locations along the length of antenna element 14b corresponding to shelves 1, 4, 5, 8, 9, 12, and 13 will not be able to receive RF signals. Antenna element 14c will be masked such that sections along the length thereof corresponding to shelf locations 1, 2, 3 and 8-11 will not be able to receive RF signals. And antenna element 14d will be masked so that sections along its length that correspond to shelf locations 1-7 will not be able to receive RF signals.

In operation it will be preferred that the antenna elements 14a-14d will be energized with electrical energy from the decoder subsystem 16 sequentially one at a time. Preferably a short, suitable time delay will be provided before energizing the next antenna element 14a-14d to enable the RFID tags time to respond back to the decoder subsystem 16 with an RF signal reply.

The table shown in FIG. 5 illustrates which antenna element 14a-14d will provide an output when a code is sensed at a given shelf location, as well as the binary output code that will be produced by the antenna system 14, and the shelf location that can be deduced therefrom by the decoder subsystem 16. For example, when code “N” is received only by antenna elements 14d and 14b, then an output of 1010 will be generated by the antenna system 10. The decoder subsystem 16 knows that code 1010 is associated with shelf location 10 and thus identifies the piece of equipment associated with code “N” as being located at shelf location 10. As another example, consider that the antenna system 14 receives code J only on antenna elements 14d, 14b and 14a. The antenna system 14 will generate a binary 1011 as an output. The decoder subsystem 16 will interpret this binary code as being associated with shelf location 11, and therefore determine that the piece of equipment associated with code J is located at shelf 11. And of course if one of the shelf locations has no equipment mounted in it, then no RFID tag will be present, meaning no code will be generated that is associated with that shelf location. The decoder subsystem 16 could be controlled to scan all of the outputs that it has received from the antenna 14 and identify which shelf locations do not have any reported codes associated therewith. In this manner all empty shelf locations can be quickly deduced.

With the system 10, the maximum number of different sites that can be sensed with any given number of antennas can be expressed with the following formula:

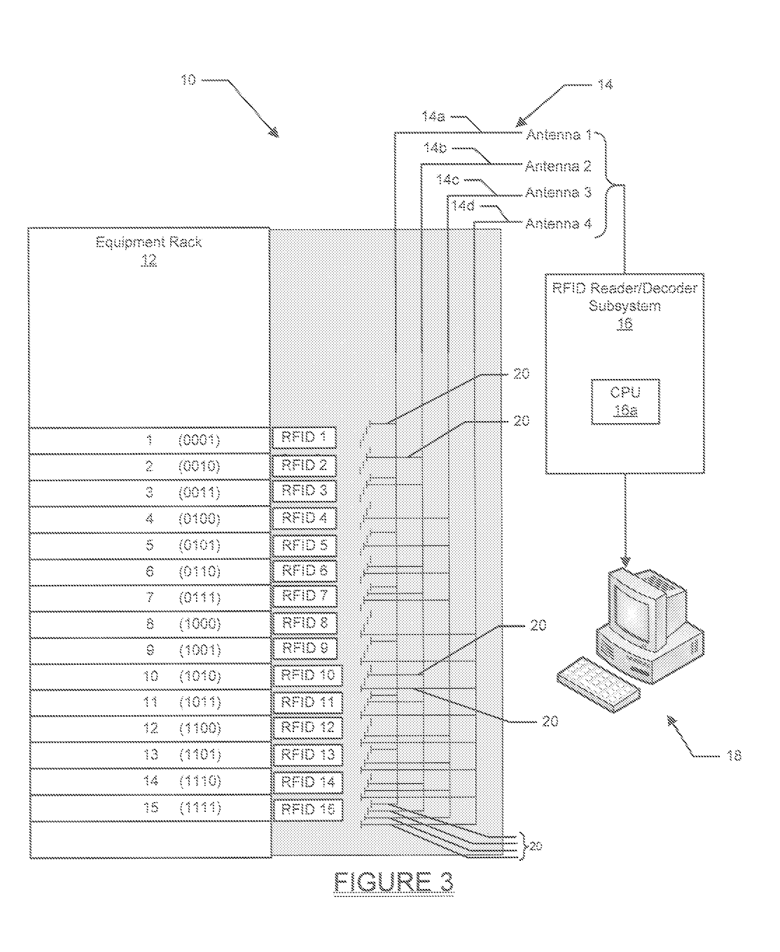

2ⁿ−1=Sites_{Max}

where “n” represents the selected number of antennas. As will be appreciated, this can make for a dramatic reduction in the number of independent antenna elements (and transmission channels) required to sense a given number of equipment locations, as compared to the prior art scheme shown in FIG. 2. This is shown graphically in FIG. 6. One skilled in the art of RF tracking systems will appreciate the significant cost and materials savings that the present disclosure provides. In particular, the reduction in electrical cabling (i.e., to implement antennas) that the system 10 provides where hundreds or thousands of data center equipment locations must be monitored can be several orders of magnitude less than the cabling required with the prior art scheme shown in FIG. 2.

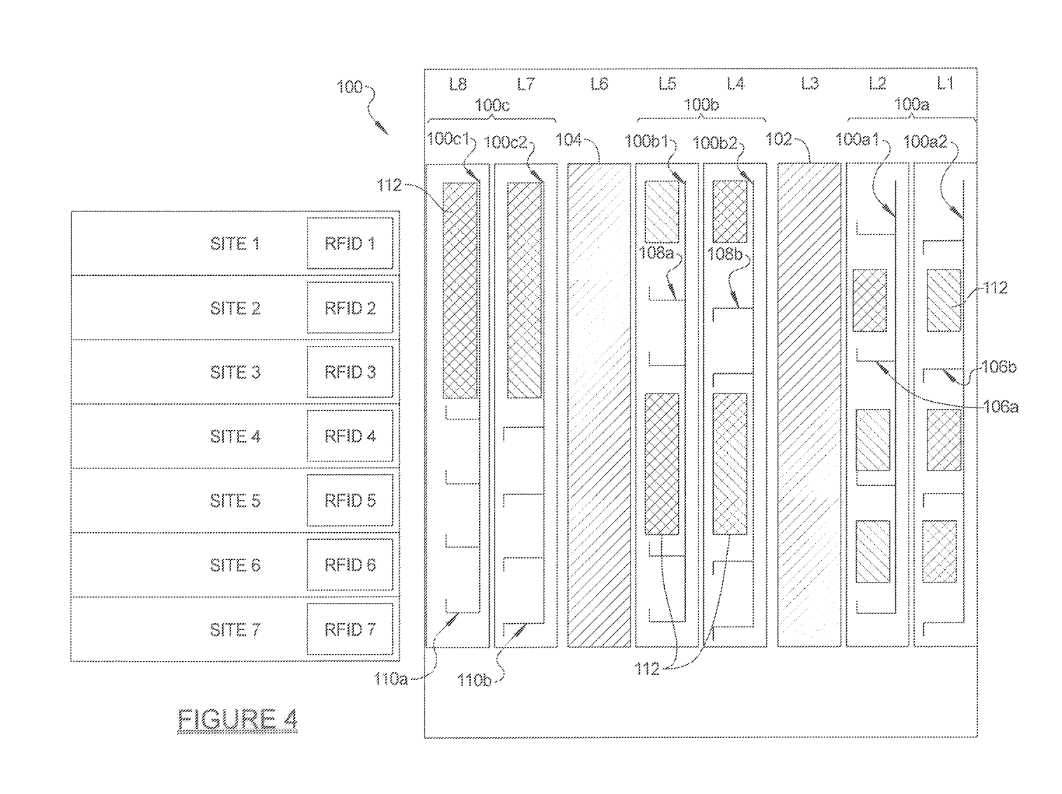

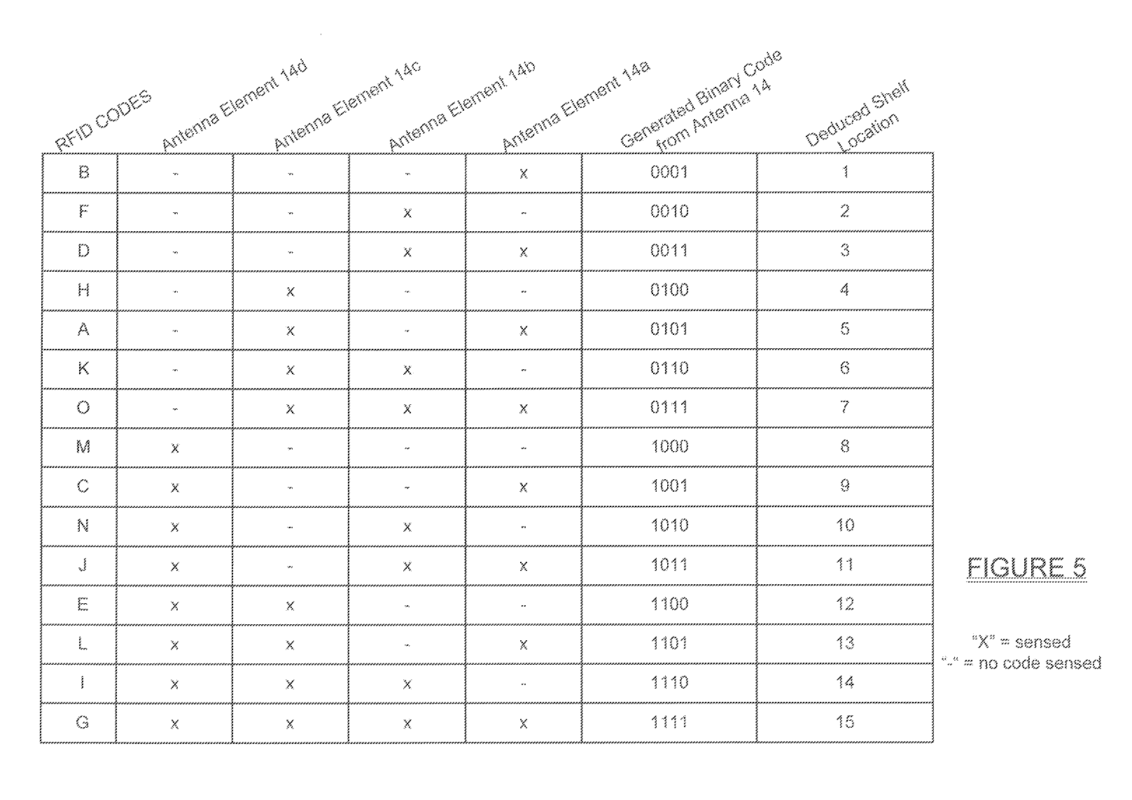

Referring to FIG. 4, another implementation of an antenna 100 in accordance with the present disclosure is shown. The antenna 100 is a three antenna element structure formed as an integrated, multi-layer assembly from a somewhat flexible material such as Mylar. Since only three antenna elements 100a, 100b and 100c are used, the antenna 100 is adapted to sense the locations of seven different RFID tags at seven different sites. Again, the different “sites” may be equipment locations such as equipment shelves within an equipment rack. Alternatively the different sites could be different, unique equipment locations (i.e., not within one equipment rack).

The antenna elements 100a, 100b and 100c are electrically isolated from one another by shielding layers 102 and 104. The shielding layers 102 and 104 are coupled to ground (not specifically shown). The shielding layers 102 and 104 may be formed by layers of copper or any other suitable, electrically conductive material. Antenna element 100a forms a dipole antenna that has two conductors 100a1 and 100a2 separated by suitable insulation (not specifically shown). Each of the two conductors 100a1 and 100a2 has receiving sections (i.e., unmasked sections) indicated schematically by dipole elements 106a and 106b, respectively. Antenna element 100b similarly has conductors 100b1 and 100b2 that include receiving sections represented schematically by dipole elements 108a and 108b, respectively, that indicate unmasked sections. Similarly, antenna element 100c has conductors 110c1 and 110c2 that include receiving sections represented schematically by dipole elements 110a and 110b, respectively, that indicate unmasked sections. Thus, each of the dipole elements 106a, 106b, 108a, 108b, 110a and 110b are able to sense RF signals from one or more of the seven RFID tags in the manner described above for antenna 14.

In the example antenna 100 shown in FIG. 4 shaded sections 112 have been presented within each of the antennas 110a, 100b and 100c. These shaded sections 112 graphically indicate optional additional shielding material that may be added at select sections along the length of each antenna element 100a, 100b and 100c to even further ensure that each of the antenna elements 100a, 100b and 100c will not be able to pick up any radiated RF energy from undesired RFID tags. By “undesired” it is meant those RFID tags that a given dipole element 106a,106b, 108a,108b or 110a,110b is not intended to sense. Depending on various factors, including the distances separating the RFID tags when they are placed on pieces of equipment and located in an equipment rack, the additional shielding sections 112 may or may not be required. Obviously, the greater the distance separating adjacent RFID tags the less likelihood there will be that one dipole element may pick up unwanted RF energy from an RFID tag that it is not intended to be sensing.

While the foregoing discussion has been centered around a standard binary encoding scheme, it will be appreciated a Gray code (i.e., reflected binary code) or virtually any other encoding scheme could be used with the present system and method. Thus, the present disclosure is not limited to use with any specific encoding scheme.

The present disclosure thus forms a highly cost effective means for sensing the locations of a large number of pieces of equipment with a dramatically reduced number of antenna elements and transmission channels. The savings in antenna elements and transmission channels essentially goes up exponentially as more and more antenna elements are required for use.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A system for identifying which equipment slots of an equipment enclosure have equipment components located in them when specific equipment components containing radio frequency identification (RFID) tags thereon are inserted into specific ones of the equipment slots, the system comprising:
an antenna system adapted to be secured to said equipment enclosure to span the equipment slots, the antenna system including:
a plurality of elongated antenna elements arranged adjacent to one another and in relation to the equipment slots of the equipment enclosure;
the antenna elements configured to wirelessly sense the presence of an RFID tag at any one of the equipment slots and to generate a plurality of different codes, with each said code being uniquely associated with at least a given one of the equipment slots, and being indicative of the sensed presence of an RFID tag at its associated said equipment slot; and
a decoder system in communication with the antenna system for decoding the unique codes generated by the antenna system and determining which specific ones of the equipment slots that an RFID tag was sensed at.

2. The system of claim 1, wherein the decoder system is configured to associate at least two adjacent ones of the equipment slots as a single equipment slot, identified by a single RFID tag.

3. The system of claim 1, wherein the plurality of codes comprises a plurality of binary codes, with a first one of the equipment slots represented by a binary 1 code, a second one of the equipment slots represented by a binary 2 code, and a third one of the equipment slots represented by a binary 3 code.

4. The system of claim 1, wherein each one of said antenna elements is associated with one bit of the binary codes.

5. The system of claim 4, wherein a first one of the antenna elements is associated with a first (2⁰) bit of the binary codes, a second one of the antenna elements is associated with a second (2¹) bit of the binary codes, and wherein an n^{th} one of the antenna elements is associated with a 2ⁿ⁻¹ bit of the binary codes.

6. The system of claim 1, wherein the decoder is preprogrammed to recognize different ones of the codes as being associated with specific ones of the equipment slots.

7. The system of claim 1, wherein the antenna elements are disposed parallel to one another and:
insulated along their lengths such that one or more first specific portions of each said antenna element are able to receive wireless signals; and
such that one or more second specific portions of each of said antenna elements are not able to receive wireless signals.

8. The system of claim 1, wherein the antenna system is secured to the equipment enclosure at a location wherein the antenna system is able to sense an RFID tag when an equipment component is inserted in any one of the equipment slots in the equipment rack.

9. The system of claim 1, wherein each said antenna element provides a unique output to the decoder system.

10. The system of claim 9, wherein the decoder system scans each of the outputs from the antenna elements to determine which equipment slots of the equipment enclosure have no equipment components located therein.

11. The system of claim 1, further comprising encoding the RFID code of each said equipment component with identifying information including at least one of the following:
a serial number;
a model number; and
a power requirement; and
wherein the antenna system is configured to transmit the identifying information to the decoder system.

12. A system for identifying which equipment slots of an equipment enclosure have equipment components located in them when specific equipment components containing radio frequency identification (RFID) tags thereon are inserted into specific ones of the equipment slots, the system comprising:
an antenna system adapted to be secured to said equipment enclosure to span the equipment slots, the antenna system including:
a plurality of elongated antenna elements arranged adjacent to one another and in relation to the equipment slots of the equipment enclosure;
each of said elongated antenna elements having at least one first portion along a length thereof which is able to receive signals generated by a RFID tag, and at least one second portion along a length thereon which is not able to receive signals from a RFID tag;
the antenna elements configured to wirelessly sense the presence of an RFID tag at any one of the equipment slots and, using the first and second portions of the antenna elements, to generate a plurality of different binary codes, each said binary code representing a unique binary code, and each said binary code being uniquely associated with at least a given one of the equipment slots and being indicative of the sensed presence of an RFID tag at said associated equipment slot; and
a decoder system in communication with the antenna system for reading the binary codes generated by the antenna system and determining which specific ones of the equipment slots that an RFID tag was sensed at.

13. The system of claim 12, wherein the decoder system is configured to associate at least two adjacent ones of the equipment slots as a single equipment slot, identified by a single RFID tag.

14. The system of claim 12, wherein the plurality of codes comprises:
a plurality of binary codes, with a first one of the equipment slots represented by a binary 1 code, a second one of the equipment slots represented by a binary 2 code, and a third one of the equipment slots represented by a binary 3 code; and
wherein a first one of the antenna elements is associated with a first (2⁰) bit of each of the binary codes;
wherein a second one of the antenna elements is associated with a second (2¹) bit of each of the binary codes; and
wherein an n^{th} one of the antenna elements is associated with a 2ⁿ⁻¹ bit of each of the binary codes.

15. The system of claim 12, wherein the antenna system is formed as a single component at least partially from Mylar.

16. The system of claim 12, wherein the elements of the antenna system are disposed parallel to one another.

17. The system of claim 12, wherein the antenna system includes an adhesive component enabling it to be adhered to an equipment rack.

18. The system of claim 12, wherein the at least one first section of each said antenna element forms a dipole antenna element.

19. A method for identifying which equipment slots of an equipment enclosure have equipment components located in them when specific equipment components containing radio frequency identification (RFID) tags thereon are inserted into specific ones of the equipment slots, the method comprising:
securing an multi element antenna system to said equipment enclosure in a manner such that the antenna system spans all the equipment slots;
selectively insulating one or more portions along a length of each said element of said multi element antenna system such that a wirelessly sensed RFID tag at any one of the equipment slots causes a unique output to be generated by the elements of the multi element antenna system, to thus form a plurality of codes, with each said code being uniquely associated with a different one of said equipment slots;
reading output signals from each of the antenna elements to construct the codes; and
using a decoder system to interpret the codes, to thus determine which one or more of said equipment slots has an equipment component installed therein.

20. The method of claim 19, wherein the codes comprise binary codes.
